(19) United States
(12) Patent Application Publication
(10) Pub. No.: US 2006/0169359 A1
(43) Pub. Date: Aug. 3, 2006

(54) Debarking apparatus with adjustable rate of debarking

(75) Inventors: Robert M. McNicol, Mission (CA); Perry E. Delano, North Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Carmanah Design and Manufacturing Inc., Vancouver (CA)

(21) Appl. No.: 11/046,008

(22) Filed: Jan. 28, 2005

(51) Int. Cl. B27L 1/00

(52) U.S. Cl. 144/208.1

(57) ABSTRACT

An adjustable debarking block for a debarker having an enclosure to receive logs for debarking in order to vary the aggressiveness of the debarking process. The block member has multiple debarking surfaces, and is movable within the enclosure between positions in which one of the surfaces is exposed to engage logs. The block member is fittable into a rotor or drum type debarker. An actuator is provided to move the block member between positions. Preferably, the actuator is an airbag or telescoping cylinder.

### FIELD OF THE INVENTION

This invention relates to debarking equipment for removing bark from raw logs, and more particularly, to adjustable debarking blocks that permit variation in the aggressiveness of debarking of logs by variation in the exposure of the blocks and the debarking surface exposed to the logs.

### BACKGROUND OF THE INVENTION

In the forest industry, raw logs are converted into many different types of products such as lumber and panel products for construction, and pulp and paper products for newsprint, fine papers and tissues. In manufacturing any of these products, bark must first be removed from the raw logs before further processing can occur.

Drum or rotor debarkers have been developed to remove bark rapidly and efficiently from logs on a large scale. In such debarkers, bark is removed from the logs primarily by mechanical abrasion as the logs rub against each other within an enclosure and against abrading projections known as flights or debarking blocks fixedly mounted within the enclosure. This rubbing action is initiated by turning a drum which defines the enclosure or by rotating one or more rotors which extend into the enclosure. The rotating action of the drum or rotors tends to cause logs within the enclosure to move in a generally circular, tumbling motion to establish the mechanical abrasion described above.

The amount of abrasion required to effectively remove bark from a log depends on factors such as the log species, age, diameter, moisture content and temperature. For effective debarking, abrasion levels must be high enough to remove all the bark while causing only minimal damage to the underlying wood surface.

In conventional drum or rotor debarkers, the extent of debarking action can be controlled by changing the rotational speed of the drum or rotors or by adjusting the amount of time the logs spend in the machine. Our co-pending U.S. patent applications Ser. No. 10/194,696 filed Jul. 12, 2002 (Internal ref: 42768-102) and commonly owned U.S. Pat. No. 6,578,609 issued Jun. 17, 2003 and U.S. Pat. No. 6,651,709 issued Nov. 25, 2003 disclose alternative arrangements for varying the aggressiveness of debarking involving reversing the rotational direction of a drum debarker and providing pivotable debarking plates in a drum debarker.

Under certain conditions, the amount of debarking action needs to be increased. In conventional practice, fixedly mounted debarking blocks with roughened or serrated surfaces are used to promote abrasion and rotation of the logs. It is well known in the art that the shape and positioning of these debarking blocks can be varied to obtain more aggressive or gentler debarking. Problems, however, arise when wood properties vary from hour to hour or batch to batch of logs. This often occurs in spring or fall, when some logs may be frozen while others are not. Debarking blocks that work well for unfrozen logs will not remove bark from frozen logs. If more aggressive blocks are used for frozen logs, unfrozen logs are damaged as excess wood is removed with the bark and valuable wood fibre is lost.

Another problem with fixedly mounted debarking blocks is that the amount of debarking action can only be varied by changing the blocks. This can take several hours resulting in considerable loss of production as the process involves emptying the debarker of logs and removing and replacing each block manually.

### SUMMARY OF THE INVENTION

To address the foregoing problems with prior art debarking equipment, the inventors have developed a rotatable debarking block that allows for the debarking action to be adjusted during machine operation based on exposure of an appropriate debarking surface. The debarking block of the present invention includes an actuator that is used to rotate the block to expose abrading surfaces of different aggressiveness.

Accordingly, in a first embodiment, the present invention provides an adjustable debarking block for a debarker having an enclosure to receive logs for debarking comprising:

a block member having at least two debarking surfaces, the member being movable within the enclosure between positions in which one of the at least two debarking surfaces is exposed to engage logs; and

an actuator to move the block member between the positions.

In a further aspect, the present invention provides a debarking system that relies on a movable surface adjacent to a fixed debarking surface to control the aggressiveness of the debarking process. In this second embodiment, the system for adjusting the aggressiveness of debarking comprises:

a plurality of fixed debarking blocks within the enclosure having debarking surfaces to engage logs;

a movable surface between the fixed debarking blocks movable between a retracted position in which the debarking surfaces of the fixed debarking blocks are exposed for aggressive debarking and an extended position in which the movable surface projects past the debarking surfaces of the fixed debarking blocks to form less aggressive debarking surface; and

an actuator to move the movable surface between the retracted and extended positions.

The apparatus of the present invention is useful in both rotor or drum style debarkers.

In the second embodiment, the actuator comprises a member such as an airbag or telescoping cylinder that is connected to a pressure reservoir.

### BRIEF DESCRIPTION OF THE DRAWINGS

Aspects of the present invention are illustrated, merely by way of example, in the accompanying drawings in which:

FIG. 1 is a cross-section view through a rotor debarker according to the prior art;

FIG. 2 is a cross-section view through a drum debarker according to the prior art;

FIG. 3 is a detail view of the debarking block of the present invention according to the first embodiment a first rotated position below a stop surface with a debarking surface of a first aggressiveness exposed;

FIG. 4 is a detail view of the debarking block of FIG. 3 in a second rotated position with a debarking surface of a second aggressiveness exposed;

FIG. 5 is a detail view of the debarking block of FIG. 3 in a third rotated position with a debarking surface of a third aggressiveness exposed;

FIG. 6 is a detail view of the debarking block of FIG. 3 in a fourth rotated position with a debarking surface of a fourth aggressiveness exposed;

FIGS. 6a to 6d show an alternative actuator arrangement for rotating the debarking block between positions;

FIG. 7 is a detail view of a second embodiment of the debarking block of the present invention in which the movable surface is retracted to expose the fixed debarking surface for aggressive debarking;

FIG. 8 is a detail view of the second embodiment with the movable surface fully extended to conceal the fixed debarking surface for less aggressive debarking;

FIG. 9 is a detail view of the second embodiment using an alternative actuator; and

FIG. 10 is a plan view of the debarking blocks and movable surface of the second embodiment showing spaced, fixed debarking blocks positioned between a series of movable surfaces connected to a common pivoting hinge.

### DESCRIPTION OF THE PREFERRED EMBODIMENTS

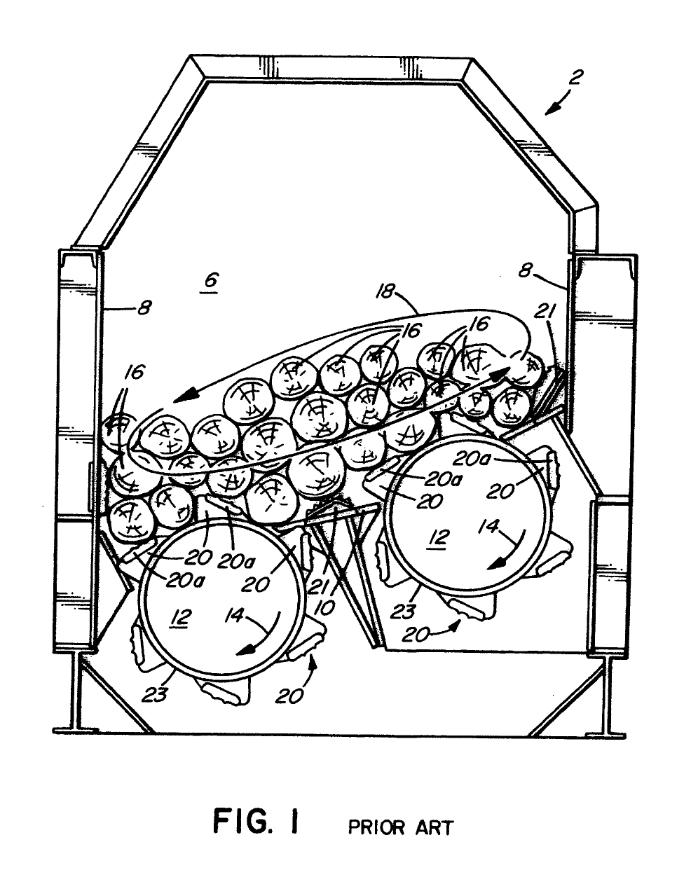

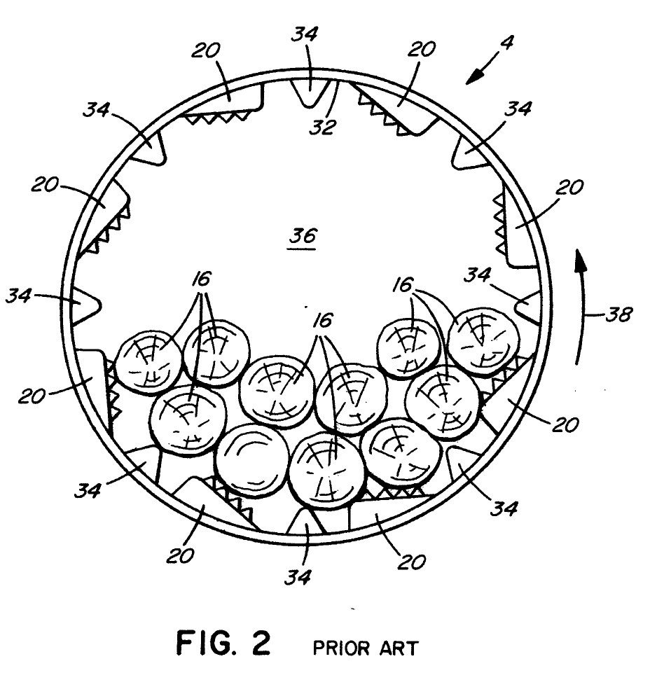

Referring to FIGS. 1 and 2, there is shown a conventional rotor debarker 2 and drum debarker 4. In the rotor debarker 2, an enclosure or trough 6 is defined by spaced side walls 8 and a floor 10. Floor 10 is sloped and interrupted by a pair of rotors 12 which are rotatably mounted to partially protrude through the floor. When rotors 12 are driven in the direction indicated by arrows 14, raw logs 16 introduced into the trough 6 are tumbled in a generally circular path indicated by arrow 18 resulting in debarking of the logs as they abrade against each other. In the illustrated rotor debarker of FIG. 1, the rotors are fitted with conventional debarking blocks 20 removably mounted to the exterior peripheral wall 23 of each rotor. Blocks 20 with external serrated debarking surfaces 20a rotate with the rotors to assist in both movement and abrasion of the logs. Fixed debarking blocks 21 are also mounted adjacent side walls 8 and intermediate the rotors on floor 10 to increase the available abrading surface. In the conventional drum debarker 4 of FIG. 2, a hollow drum 30 is mounted for rotation about a substantially horizontal axis. In fact, the axis is typically tilted at a slight angle to aid in material flow from one end of the debarker to the other. The interior wall 32 of drum 30 is formed with a series of inwardly extending projections or flights 34 which also extend along the length of the drum interior. Flights 34 act to lift logs 16 within the drum interior 36 as the drum rotates in the direction of arrow 38. Once the lifted logs reached a certain point, they tend to tumble down under gravity to the lower portion of the drum. In tumbling, the logs collide and abrade against other logs and the sides of the drum to establish the debarking action of the drum debarker. As with the rotor debarker 2 of FIG. 1, the drum debarker 4 of FIG. 2 is fitted with debarking blocks 20 with serrated debarking surfaces 20a that assist in lifting and abrading the logs. With conventional drum or rotor debarkers, blocks 20 must be manually removed and left off or replaced with blocks having different debarking surfaces 20a in order to vary the aggressiveness of debarking. The debarking blocks are typically held in place using a series of bolts, and the removal and installation of blocks 20 is a time consuming job.

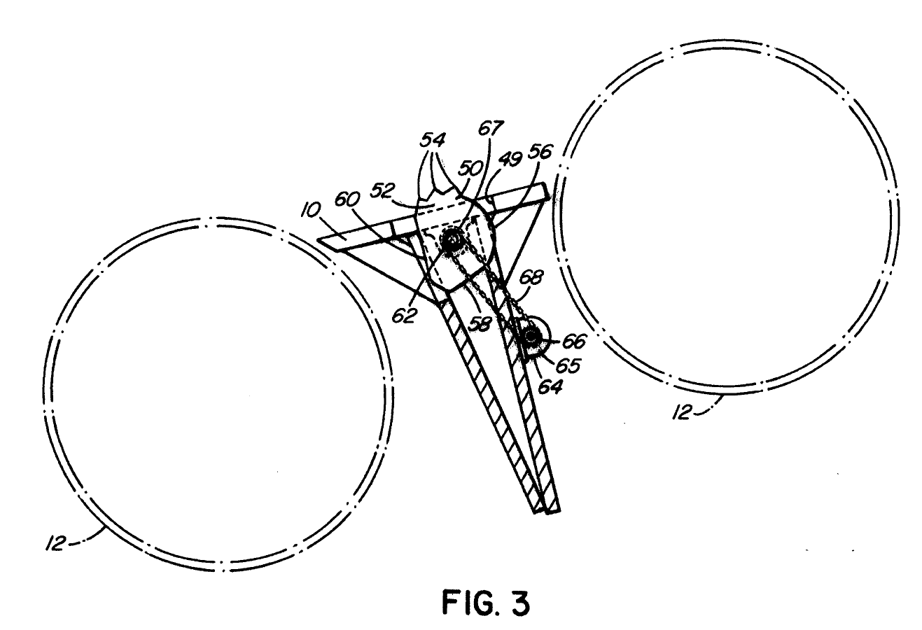

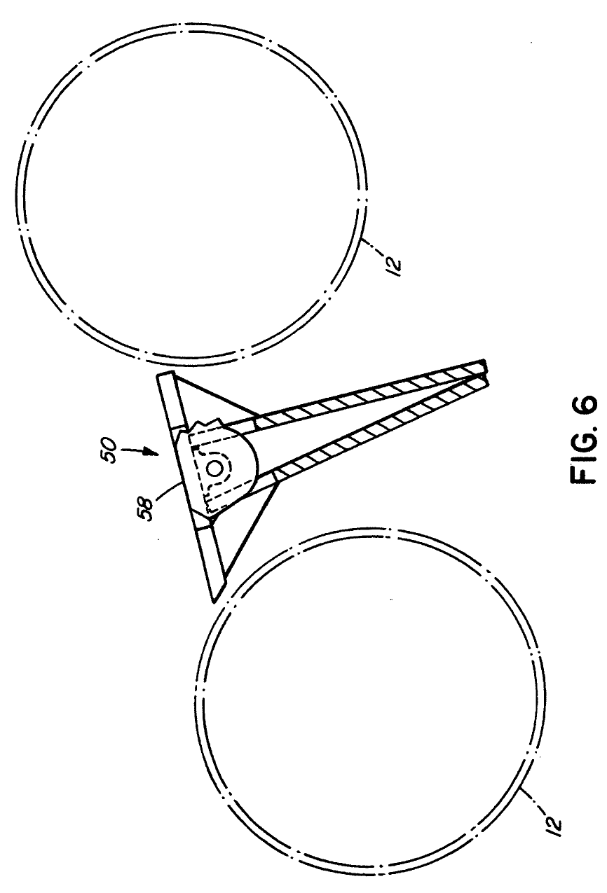

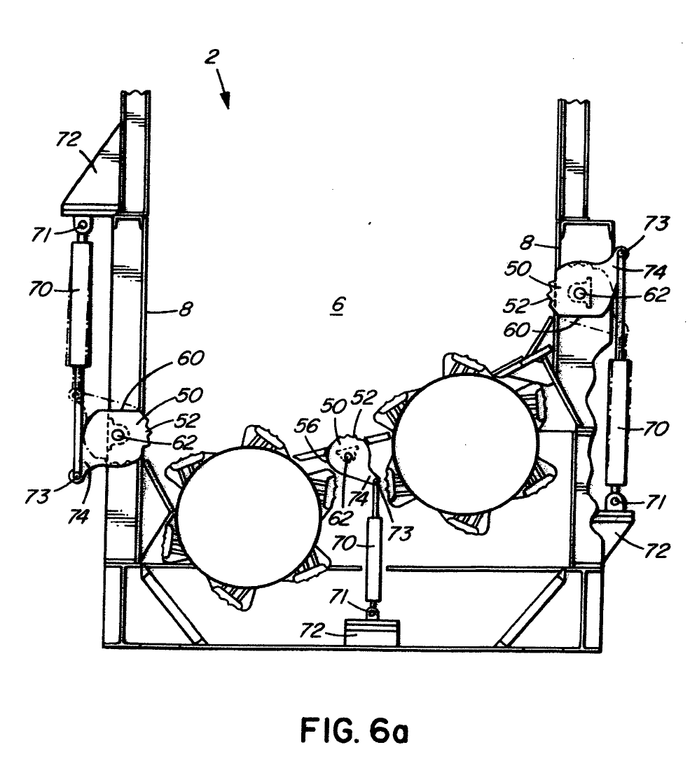

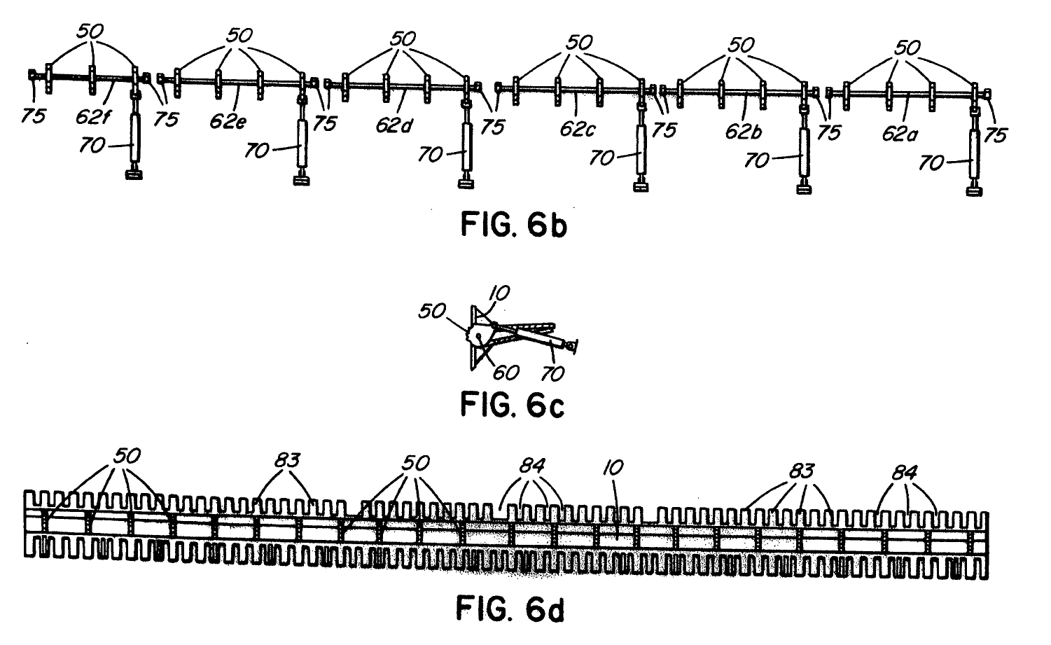

Referring to FIGS. 3 to 6, there is shown a first embodiment of a rotatable debarking block 50 according to the present invention. Debarking block 50 is installable in any location that a conventional fixed debarking block is mounted. For example, debarking block 50 is mountable to the interior surface of a drum debarker or the exterior wall of a rotor to replace the conventional debarking blocks 20 illustrated in FIGS. 1 and 2. In the case of a rotor debarker, rotatable debarking blocks 50 can also be mounted in or adjacent the side walls 8 or floor 10 (between rotors 12) of log trough 6 as best shown in FIGS. 6a. By way of example in FIGS. 3 to 6, rotatable debarking block 50 is shown mounted within a cavity 49 formed in floor 10 of a rotor debarker between rotors 12. The block is rotatable within cavity 49 to exposed one of a plurality of surfaces to the interior of the debarker. The arrangement of the present invention is not limited to this position as set out above.

Debarking block 50 comprises a block member having at least two debarking surfaces of differing aggressiveness. In FIGS. 3 to 6, block 50 has four different debarking surfaces: a first serrated surface 52 with a plurality of protruding teeth 54, a second surface 56 with a rounded profile, a third surface 58 with a protruding point, and a fourth surface 60 with a flat profile. Debarking block 50 is movable by rotation within cavity 49 between different positions as illustrated in FIGS. 3 to 6. At each position, one of the debarking surfaces is exposed within enclosure 6 of the debarker to engage logs for debarking. Each debarking surface is shaped to debark logs to a different degree.

In the arrangement illustrated in FIG. 3, block 50 is fixedly mounted to a shaft 62 which is rotated by an actuator 64 to move the block member between the different positions. In FIG. 3, actuator 64 comprises a motor 65 with a drive cog 66 that is connected to a corresponding gear 67 on shaft 62 by a chain 68. Operation of motor 65 to rotate drive cog 66 acts move chain 68 which results in corresponding rotation of gear 67 and shaft 62. In a preferred arrangement, shaft 62 extends along substantially the entire length of debarker trough 6 with a plurality of debarking blocks 50 arranged along the length of the shaft such that a single actuator 64 can rotate multiple blocks.

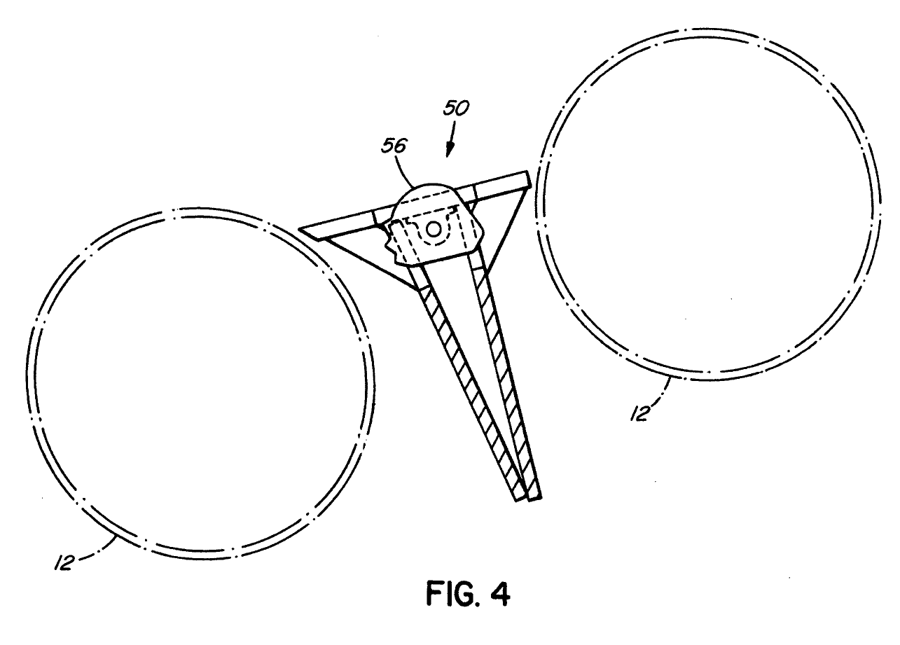

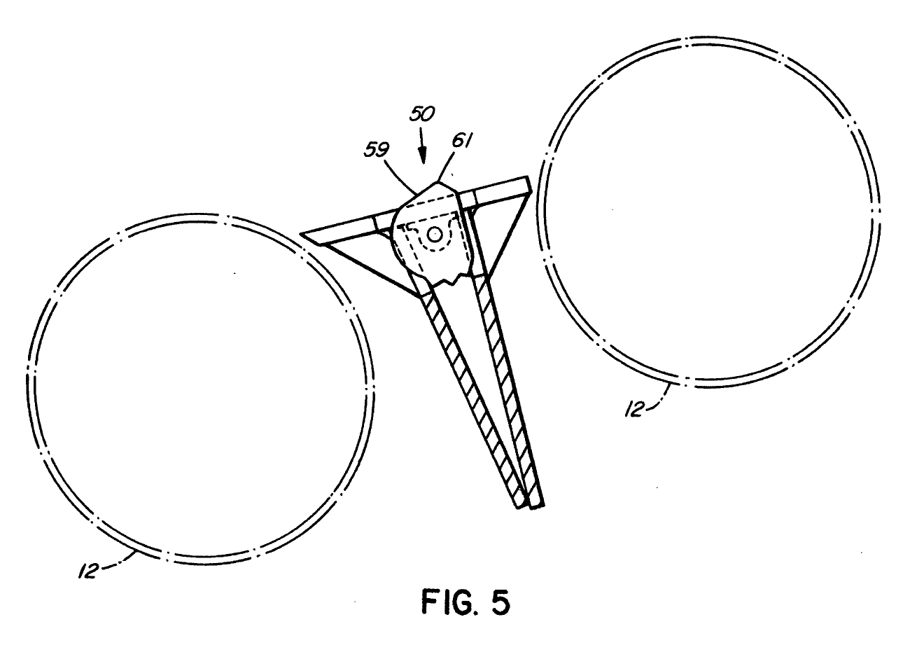

FIG. 3 illustrates debarking block 50 rotated to the first position in which first surface 52 with teeth 54 is exposed for aggressive debarking of logs. FIG. 4 is identical to FIG. 3 except that block 50 has been rotated by actuator 64 to the second position in which second surface 56 with a rounded profile is exposed for less aggressive debarking. FIG. 5 shows third surface 59 exposed with a projecting point 61 for less aggressive debarking of logs and FIG. 6 shows fourth surface 60 exposed with a flat profile for the least aggressive debarking action. In each position, a single surface is exposed for debarking action and the remaining surfaces are concealed within cavity 49.

It will be apparent that the rotatable debarking block 50 of the present invention is not limited to the four debarking surfaces illustrated and described above. The present invention contemplates the use of any debarking block with two or more different debarking surfaces rotatable into position to vary the debarking rate.

FIG. 6a shows an alternative actuator arrangement for the rotatable debarking block 50 of the present invention. FIG. 6a also shows a plurality of rotatable debarking blocks located in typical operating positions within the trough 6 of rotor debarker 2. As in the previously described embodiment, each debarking block 50 is fixedly mounted to shaft 62 such that rotation of the shaft acts to expose one of the at least two debarking surfaces 52, 60 of differing aggressiveness. An actuator in the form of cylinder 70 is used to rotate debarking block 50. Cylinder 70 is pivotally mounted at end 71 to fixed bracket 72. At the opposite end 73, the cylinder is pivotally mounted to debarking block 50 such that any change in the length of the cylinder acts to rotate debarking block 50 about shaft 62 to expose a debarking surface within trough 6. FIG. 6a shows the debarking blocks 50 mounted in the left and right side walls 8 of the trough in two different positions: a first position shown by solid lines in which aggressive debarking surface 52 is exposed and a second position shown by dashed lines in which the block is rotated through approximately ninety degrees to expose less aggressive debarking surface 60. Cylinder 70 can be a hydraulic or pneumatic cylinder. As illustrated, end 73 of the cylinder is preferably pivotally attached to a lobe 74 extending from debarking block 50.

FIGS. 6b to 6d provide schematic views of a preferred manner in which the rotating debarking blocks of the present invention can be installed within the trough of a rotor debarker. FIG. 6b is essentially a side elevation view, FIG. 6c an end view and FIG. 6d a plan view showing the general placement of a collection of rotatable blocks 50 mounted within the floor 10 of a rotor debarker. The Figures omit the side walls and the rotors of the debarker for clarity. The debarking blocks 50 are mounted to protrude through openings in floor 10. Floor 10 is bounded on either side by a plurality of spaced fingers 83 which define openings 84 therebetween for passage of the debarking blocks mounted to the rotors (not shown) of the debarker and for passage of bark removed from the logs. The debarking blocks 50 are positioned in spaced relationship along floor 10 to protrude above the floor as best shown in FIG. 6c. Referring to FIG. 6b, sets of debarking blocks 50 are each fixedly mounted to a rotatable shaft. In the illustrated embodiment, six separate shafts 62a to 62f are shown with each shaft supported independently by end bearings 75. It will be appreciated that the number of shafts and the number of debarking blocks 50 supported by each shaft are design considerations that will depend, amongst other things, on the length of the debarking trough. In the illustrated embodiment, each shaft 62a, 62b, 62c, 62d, 62e and 62f includes a single debarking block 50′ that is pivotally connected to one of a plurality of spaced actuating cylinders 70. Movement of debarking block 50′ by cylinder 70 acts to rotate the shaft to which all other blocks 50 are mounted such that all blocks are moved to the same position by a single cylinder 70. It will be appreciated that more than one cylinder can be used to control the movement of a shaft. The arrangement shown in FIGS. 6b to 6d allows for debarking blocks 50 to be set to different levels of aggressiveness along the length of the debarker with the provision that all blocks connected to a particular shaft are set at the same aggressiveness.

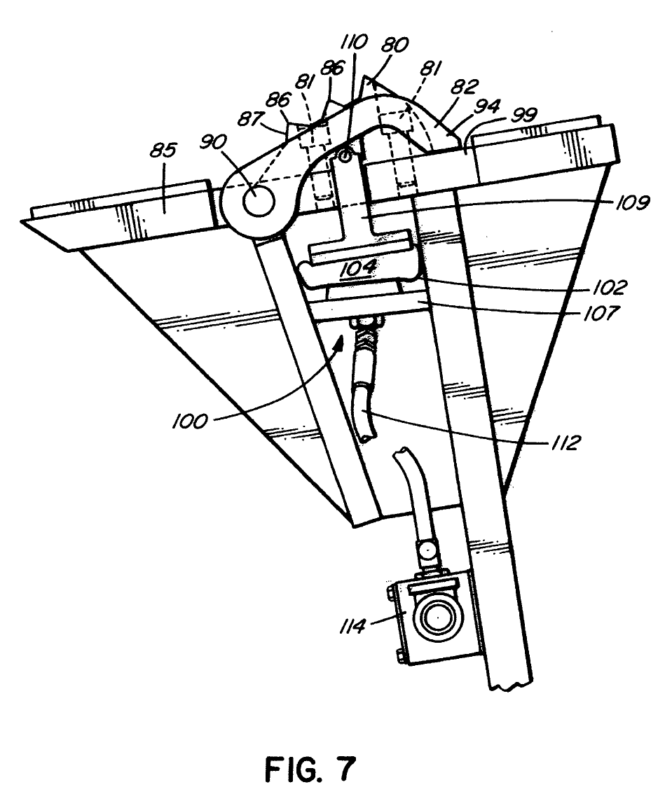

In a second aspect which is illustrated in FIGS. 7 to 10, the present invention provides a system for adjusting the aggressiveness of debarking in a debarker which relies on a plurality of fixed debarking blocks positioned adjacent a movable surface that is movable to expose or conceal the debarking blocks.

Referring to FIGS. 7 to 10, the second embodiment comprises fixed debarking block 80 and movable surface 82 which are installable in any location that a conventional debarking block is mounted. For example, debarking block 80 and movable surface 82 of the present invention are mountable to the interior surface of a drum debarker or the exterior wall of a rotor to replace the conventional debarking blocks 20 illustrated in FIGS. 1 and 2. In the case of a rotor debarker, the system of the second embodiment can also be mounted in or adjacent the side walls 8 or floor 10 (between rotors 12) of log trough 6. In FIGS. 7 to 10, surface 85 represents the mounting surface of the rotor or drum.

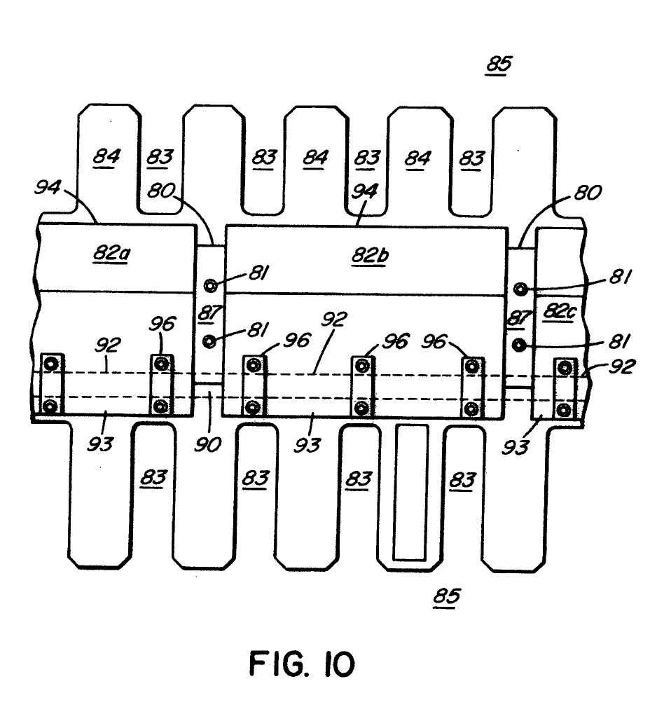

As best shown in FIG. 10, which is a plan view of the system of the second embodiment, fixed debarking blocks 80 are held in place by fasteners 81 which are received in the mounting surface 85 of the rotor or drum. Debarking blocks 80 are preferably mounted in a region bounded by a plurality of spaced fingers 83 which define openings 84 therebetween for passage of bark removed from the logs. A plurality of fixed debarking blocks 80 are positioned in spaced relationship and the movable surface 82 extends between the fixed debarking blocks in a plurality of discontinuous sections 82a, 82b, 82c. Three sections are illustrated and described in the following discussion, however, it will be appreciated that the number of sections will depend, among other factors, on the number of fixed debarking blocks and the length of the debarking enclosure. In a drum debarker, the plurality of fixed debarking blocks are mounted in spaced relationship to an interior side wall of a drum defining the enclosure to receive logs, and the movable surface extends between the fixed debarking blocks in discontinuous sections. In a rotor debarker, the plurality of fixed debarking blocks are mounted in spaced relationship to an exterior surface of the rotor within the enclosure to receive logs, and the movable surface extends between the fixed debarking blocks in discontinuous sections.

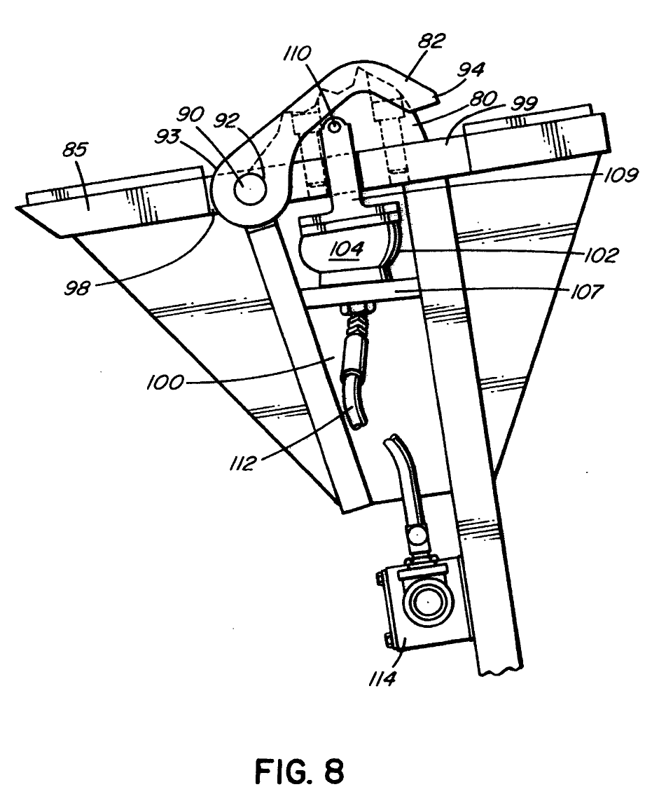

In the illustrated embodiment, fixed blocks 80 have a generally arcuate upper debarking surface 87 (shown in elevation view in FIG. 7) with a plurality of upwardly extending teeth 86. Sections of the movable surface 82 extend between pairs of adjacent fixed debarking blocks. Each movable surface section is preferably a plate of curved configuration having a generally curved top surface adapted to substantially conform to the outline of the fixed debarking blocks and debarking surface 87. Each plate section 82a, 82b, 82c of movable surface 82 is movable between a retracted position (FIG. 7) in which debarking surface 87 of the fixed debarking block is exposed above surface 82 for aggressive debarking and an extended position (FIG. 8) in which the movable surface 82 projects past the debarking surfaces to form a less aggressive debarking surface for engaging logs.

Each section 82a, 82b, 82c of movable surface 82 is preferably pivotally mounted for movement between the retracted and extended positions. FIGS. 7 to 10 show a pivot point defined by a rotatable hinge or shaft 90 adjacent one edge of the movable surface 82. Shaft 90 extends through an opening 92 formed in each plate section 82a, 82b, 82c etc. to define a pivotally mounted edge 93. A plurality of clamps 96 (see FIG. 10) at pivotally mounted edge 93 are tightenable about shaft 90 to anchor the plate sections to the shaft for movement with the shaft. The opposite edge of each plate section defines a free edge 94.

As best shown in FIGS. 7 to 9, pivotally mounted edge 93 of each plate section is located in a cavity 98 formed in mounting surface 85 of the debarker. In a preferred arrangement, a stop surface 99 is formed at free edge 94 to engage the free edge of the plate section to define the retracted position of the plate section.

Referring to FIG. 10, a series of discontinuous plate sections 82a, 82b, 82c of movable surface 82 are preferably mounted to a common hinge or shaft 90 for pivotal movement between the extended and retracted positions. It will be appreciated that different, independently movable shafts can be arranged in a debarker such that different portions of the debarking enclosure can be set up to debark at different rates depending on the pivoted position of the plate sections on a particular shaft. Each movable surface 82 may be driven by a separate actuator. For example, fixed debarking blocks 80 may be mounted on one foot centres and movable surface 82 would be formed from multiple plate sections mounted to a common shaft spanning five debarking blocks. Such an arrangement would require six movable surfaces 82, each five feet in length for a typical thirty foot long debarker module.

Movement of the movable surface 82 between the retracted and extended positions is performed by an actuator 100. FIGS. 7 and 8 illustrate a preferred actuator comprising a resilient member 102 in the form of an airbag 104 which is inflatable to move the movable surface to the extended position (FIG. 8) and deflatable to allow the movable surface to move to the retracted position (FIG. 7). Airbag 104 is mounted between a fixed surface 107 and a movable piston 109. Piston 109 is pivotally mounted to the underside of movable surface 82 at pivot 110. By virtue of shaft 90 having mounted thereto a plurality of plate sections 82a, 82b, and 82c, a single actuator 100 under at least one of the plate sections will control the movement of all the plate sections connected to the same shaft 90. It is also possible to provide an actuator under each section for redundancy.

Air bag 104 communicates via line 112 with an air pressure supply provided by header 114 in the illustrated example. The air pressure in header 114 is controlled via a pressure regulating valve (not shown). For a rotor debarker, header 114 is centrally located at the axis of rotation of the shaft and the air is piped into the header through a rotating air fixture at the centre of the rotor shaft. In a drum debarker, the header comprises a sealed air chamber incorporated around the periphery of the drum as is commonly done on ring debarkers.

Pressure in air bag 104 will cause the bag to expand to pivot movable surface 82 about shaft 90 into the extended position shown in FIG. 8. Release of pressure from air bag 104 will pivot movable surface 82 to the retracted position shown in FIG. 7. The retracted position of movable surface 82 is defined by contact of the free edge 94 of the movable surface with stop surface 99.

While the embodiment of FIGS. 7 and 8 employs an air bag 104 in actuator 100, other resilient members operable to move movable surface 82 between the retracted and exposed positions are also possible in the present invention. Resilient member 102 may comprise a telescoping cylinder pivotally connected at each end to fixed surface 107 and movable surface 82. The cylinder can be driven by pneumatic or hydraulic pressure and connected to an appropriate air or fluid reservoir.

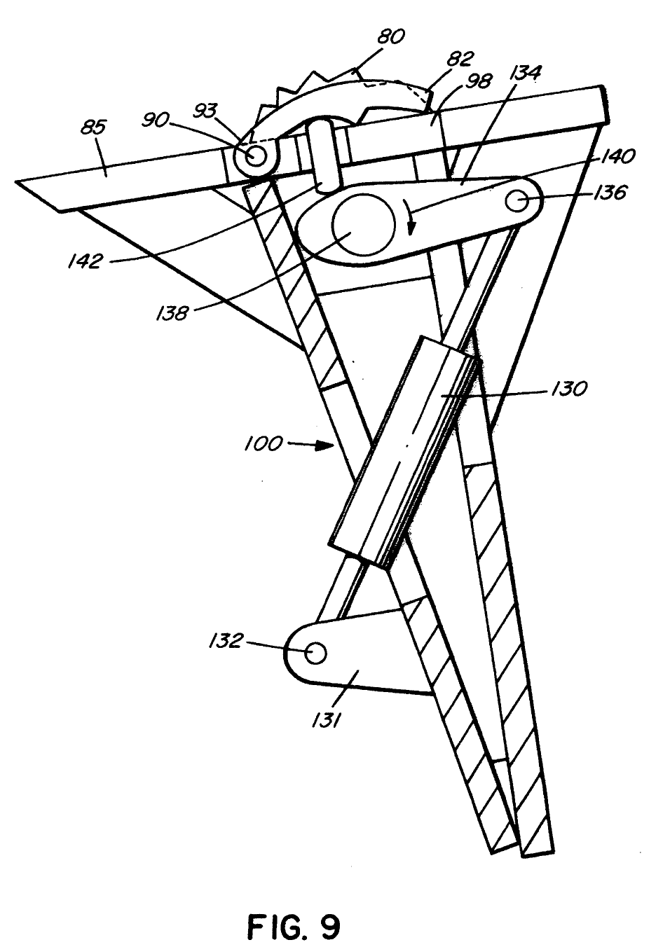

FIG. 9 illustrates an alternative actuator arrangement for movement of movable surface 82 between the retracted and extended positions. In FIG. 9, actuator 100 comprises a cylinder 130 pivotally mounted to a fixed bracket 131 at one end 132 and pivotally mounted to a cam member 134 at the opposite end 136. Cylinder 130 is powered hydraulically or pneumatically. Cam member 134 is pivotally mounted at shaft 138 such that shortening of cylinder 130 causes cam member 134 to pivot clockwise as indicated by arrow 140. This, in turn, causes a cam follower 142 to engage movable surface 82 to pivot the surface upwardly about shaft 90 to fully or partially conceal fixed debarking block 80. Similarly, lengthening of cylinder 130 results in counterclockwise rotation of cam 134 about shaft 138 to lower follower 142 thereby moving movable plate toward the exposed position of fixed debarking block 80. Cylinder 130 is preferably operable over a range of pressures to permit variation in the position of movable surface 82 and the extent to which the debarking surface of fixed debarking block 80 is exposed. In other words, intermediate positions of movable surface 82 are possible between the fully retracted and fully extended positions to vary debarking aggressiveness by varying cylinder pressure.

A further alternative arrangement for actuator 100 is to replace cylinder 130 and cam 134 with a slidable wedge member that engages follower 142. Sliding the wedge member to position a thicker region of the member below follower 142 would raise the movable surface to fully or partially conceal the fixed debarking block. Sliding a thinner region of the wedge member below follower 142 would result in lowering of the movable surface toward the exposed position of the fixed debarking block. In an additional variation, the wedge member may directly engage the movable surface rather than operating through follower 142.

Although the present invention has been described in some detail by way of example for purposes of clarity and understanding, it will be apparent that certain changes and modifications may be practised within the scope of the appended claims.

We claim:

1. An adjustable debarking block for a debarker having an enclosure to receive logs for debarking comprising:
a block member having at least two debarking surfaces, the member being movable within the enclosure between positions in which one of the at least two debarking surfaces is exposed to engage logs; and
an actuator to move the block member between the positions.

2. A debarking block as claimed in claim 1 in which the block member is mounted for rotatable movement between the positions.

3. A debarking block as claimed in claim 1 in which the block member is installable in a cavity formed in the enclosure to receive logs.

4. A debarking block as claimed in claim 1 for use in a drum debarker in which the block member is installable in a cavity formed in an interior side wall of a drum defining the enclosure to receive logs.

5. A debarking block as claimed in claim 1 for use in a rotor debarker in which the block member is installable in a cavity formed in an exterior surface of a rotor within the enclosure to receive logs.

6. A debarking block as claimed in claim 1 in which the block member is mountable within a cavity openable into the enclosure for rotation to expose one of the at least two surfaces to the enclosure.

7. A debarking block as claimed in claim 1 in which block member includes a surface formed with a plurality of projecting teeth.

8. A debarking block as claimed in claim 1 in which the block member includes a surface formed with a rounded profile.

9. A debarking block as claimed in claim 1 in which the block member includes a surface formed with a flat profile.

10. A debarking block as claimed in claim 1 in which the block member includes a surface formed with a projecting point.

11. A debarking block as claimed in claim 1 in which the block member includes four surfaces with each surface being shaped to debark logs to a different degree.

12. A debarking block as claimed in claim 11 in which the block member includes a first surface with a plurality of projecting teeth for aggressive debarking of logs, a second surface with a rounded profile and a third surface with a projecting point for less aggressive debarking of logs, and a fourth surface with a flat profile for least aggressive debarking of logs.

13. A debarking block as claimed in claim 1 in which the actuator comprises a rotatable shaft to which the block is fixedly mounted, the shaft being rotatable to rotate the block to the different positions to expose one of the at least two debarking surfaces.

14. A system for adjusting the aggressiveness of debarking in a debarker having an enclosure to receive logs for debarking comprising:
a plurality of fixed debarking blocks within the enclosure having debarking surfaces to engage logs;
a movable surface between the fixed debarking blocks movable between a retracted position in which the debarking surfaces of the fixed debarking blocks are exposed for aggressive debarking and an extended position in which the movable surface projects past the debarking surfaces of the fixed debarking blocks to form less aggressive debarking surface; and
an actuator to move the movable surface between the retracted and extended positions.

15. A system as claimed in claim 14 in which the plurality of fixed debarking blocks are positioned in spaced relationship within the enclosure to receive logs, and the movable surface extends between the fixed debarking blocks in discontinuous sections.

16. A system as claimed in claim 14 for use in a drum debarker in which the plurality of fixed debarking blocks are mounted in spaced relationship to an interior side wall of a drum defining the enclosure to receive logs, and the movable surface extends between the fixed debarking blocks in discontinuous sections.

17. A system as claimed in claim 14 for use in a rotor debarker in which the plurality of fixed debarking blocks are mounted in spaced relationship to an exterior surface of a rotor within the enclosure to receive logs, and the movable surface extends between the fixed debarking blocks in discontinuous sections.

18. A system as claimed in claim 15 in which each section of the movable surface comprises a plate pivotally mounted for movement between the retracted and extended positions.

19. A system as claimed in claim 18 in which the plate includes a top surface adapted to substantially conform to an outline of the fixed debarking blocks when the plate is pivoted to the extended position.

20. A system as claimed in claim 19 in which the plate is formed with a curved configuration.

21. A system as claimed in claim 19 in which the plate extends between a pivotally mounted edge and a free edge.

22. A system as claim in claim 21 in which the pivotally mounted edge of the plate is housed in a cavity formed in the enclosure of the debarker.

23. A system as claimed in claim 21 including a stop surface to engage the free edge of the plate to define the retracted position of the plate.

24. A system as claimed in claim 15 in which the discontinuous sections of the movable surface are mounted to a common hinge member for pivotal movement between the extended and retracted positions.

25. A system as claimed in claim 14 in which the actuator comprises a resilient member operable to move the movable surface between the retracted and extended positions.

26. A system as claimed in claim 25 in which the resilient member comprises an air bag inflatable to move the movable surface to the extended position and deflatable to allow the movable surface to move to the retracted position.

27. A system as claimed in claim 14 in which the actuator comprises a cylinder member operable to move the movable surface between the retracted and extended positions.

28. A system as claimed in claim 27 in which the cylinder member is operable to permit movement of the movable surface to intermediate positions between the retracted position and the extended position.

29. A system as claimed in claim 14 in which the actuator comprises a wedge member adjustable in position to move the movable surface between the retracted and extended positions.
